(19) United States
(12) Patent Application Publication
(10) Pub. No.: US 2021/0252905 A1
(43) Pub. Date: Aug. 19, 2021

(54) PERSONALIZED CRAFT AND A KIT AND METHOD THEREFOR

(71) Applicant: Ann Williams Group LLC, Bloomfield Hills, MI (US)

(72) Inventor: Sheila A. Wright, Bloomfield Hills, MI (US)

(21) Appl. No.: 17/178,128

(22) Filed: Feb. 17, 2021

Related U.S. Application Data
(60) Provisional application No. 62/977,878, filed on Feb. 18, 2020.

(51) Int. Cl. B44D 2/00; G09B 11/04

(52) U.S. Cl. CPC B44D 2/002; G09B 11/04

(57) ABSTRACT

The present teachings generally relate to a personalized craft, and a kit, and a method for the personalized craft. The personalized craft includes: one or more components, one or more questionnaires, and one or more assembly instructions, the one or more assembly instructions corresponding to each of the plurality of answers. The one or more questionnaires include one or more inquiries and a plurality of answers to each of the one or more inquiries. Each of the one or more assembly instructions are a step of assembly of the one or more components to fabricate the personalized craft.

### FIELD

The present teachings generally relate to a personalized craft, kit for a personalized craft, and method for creating a personalized craft.

### BACKGROUND

Crafts have long been an activity enjoyed by children and adults alike. Crafts entice the imagination as well as the natural inclination to exercise artistic skill. Crafters can conceptualize a final product and bring that final product to fruition through careful selection of materials and physical arrangement of these materials. The process of crafting hones fine motor skills, attention to detail, and planning. These exercises of imagination and skill are particularly important in young children, who are constantly in a state of active learning and require mental stimulation to excel in learning.

Some conventional crafts are assembled according to step-by-step instructions to result in a pre-determined design. These crafts may include bracelets, dream catchers, god's eyes, and knitting. No matter who is to assemble this type of craft, each person would conclude the craft with a substantially similar result in styles, colors, and design. Other conventional crafts are assembled according to the subjective whims of crafters. Assembly is directed by in-the-moment decisions regarding what element has a favorable appearance with other elements. Other than assembly steps, the crafter is not provided with direction as to what aesthetic characteristics to choose.

Crafting with other participants may involve little to no communication between crafters because each participant is enthralled in their own craft. Multiple participants working on a single craft may invite disagreement as to how the craft should be fabricated and the crafters may be focused on assembling the craft rather than engaging in conversation to become better acquainted with one another.

It would be desirable to provide a unique and unconventional craft that translates personality traits, preferences, mood, emotions, or any combination thereof, into physical characteristics of the craft.

It would be desirable to provide a unique and unconventional craft that hones fine motor skills, creativity, analytical skills, teamwork skills, communication skills, or any combination thereof.

It would be desirable to provide a unique and unconventional craft that can operate as a learning tool.

It would be desirable to provide a unique and unconventional craft that can be repeated and yield a finished product with a different appearance and/or configuration each time.

It would be desirable to provide a unique and unconventional craft that guides multiple participants to communicate and become better acquainted to each other, through thought-invoking questions, while assembling the craft.

### SUMMARY

The present disclosure relates to a personalized craft, which may address at least some of the needs identified above, the personalized craft comprising: one or more components; one or more questionnaires, including: one or more inquiries and a plurality of answers to each of the one or more inquiries; and one or more assembly instructions, corresponding to each of the plurality of answers; wherein each of the one or more assembly instructions are related to assembly of the one or more components to fabricate the personalized craft.

The present disclosure relates to a kit for a personalized craft, which may address at least some of the needs identified above, the kit comprising: one or more components; one or more questionnaires, including: one or more inquiries, and a plurality of answers to each of the one or more inquiries; and one or more assembly instructions, corresponding to each of the plurality of answers; and wherein each of the one or more assembly instructions are related to assembly of the one or more components to fabricate the personalized craft.

The present disclosure relates to a method for making a personalized craft, which may address at least some of the needs identified above, the method comprising: (a) providing one or more questionnaires, the one or more questionnaires including one or more inquiries and a plurality of answers to each of the one or more inquiries; (b) directing one or more participants to select one of the plurality of answers, and (c) directing the one or more participants to physically arrange one or more media onto one or more substrates in accordance with one or more assembly instructions associated with the one of the plurality of answers.

### BRIEF DESCRIPTION OF THE DRAWINGS

FIG. 1 illustrates a flowchart of a method.

FIG. 2A illustrates an assembly step for a personalized craft.

FIG. 2B illustrates an assembly step for a personalized craft.

FIG. 2C illustrates an assembly step for a personalized craft.

FIG. 3 illustrates a questionnaire.

FIG. 4A illustrates an assembly step for a personalized craft.

FIG. 4B illustrates a personalized craft after the assembly step of FIG. 4A is complete.

FIG. 4C illustrates an assembly step for a personalized craft.

FIG. 5 illustrates a questionnaire

FIG. 6A illustrates an assembly step for a personalized craft.

FIG. 6B illustrates a personalized craft after the assembly step depicted in FIG. 6A.

FIG. 6C illustrates an assembly step for a personalized craft.

FIG. 7 illustrates a questionnaire.

### DESCRIPTION

The present teachings meet one or more of the above needs by the improved personalized craft, kit for a personalized craft, and method for creating a personalized craft described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the below description, but should instead be determined with reference to the appended claims, along with the full scope of equivalents to which such claims are entitled. The disclosures of all articles and references, including patent applications and publications, are incorporated herein by reference for all purposes. Other combinations are also possible as will be gleaned from the following claims, which are also hereby incorporated by reference into this written description.

The present disclosure relates to a personalized craft. The personalized craft may function to translate personality traits, preferences, mood, emotions, or any combination thereof, into physical characteristics of the personalized craft. The personalized craft may function as a wearable accessory, decorative accessory, game, communication aid, learning aid, the like, or any combination thereof. Personality traits, preferences, mood, emotions, or any combination thereof may be represented by physical characteristics including color, texture, shape, size, the like, or any combination thereof. The personalized craft may include any type of craft. The personalized craft may include wearable accessory crafts, decorative accessory crafts, game crafts, or any combination thereof. The personalized craft may comprise one or more components, questionnaires, or both. The craft may involve one or more assembly steps. The assembly steps may involve the arrangement, movement, manipulation, holding, or any combination thereof, of the components. The assembly steps may include wrapping, weaving, twisting, tying, folding, gluing, tearing, cutting, coloring, painting, dyeing, the like, or any combination thereof, of the components. The assembly steps may be directed by one or more questionnaires. The components, questionnaires, or both may be configured for use with one or more types of crafts. For example, string for a god's eye may also be used for a dream catcher. The personalized craft may be fabricated by one or more participants. As referred to herein, “participants” or “crafters” may refer to any person assembling or involved in assembling the personalized craft. For example, a single participant may read a questionnaire and perform assembly steps pursuant to the direction of the questionnaire. As another example, two participants may work on the same personalized craft and take turns performing assembly steps pursuant to the direction of a questionnaire. Participants may read inquiries, provide answers to inquiries that have associated assembly instructions, fabricate the personalized craft according to assembly instructions, or any combination thereof.

The personalized craft may include a wearable accessory craft. The wearable accessory craft may function to be worn. The wearable accessory craft may be worn on a body, article of clothing, bag, purse, backpack, the like, or any combination thereof. The wearable accessory craft may include an article of clothing, piece of jewelry, pin, keychain, patch, the like, or any combination thereof. The article of clothing may include shirts, pants, shorts, skirts, socks, mittens, gloves, scarves, hats, glasses, hair accessories, the like, or any combination thereof. The wearable accessory craft may be woven, crocheted, knitted, sewn, the like, or any combination thereof. A non-limiting example of a suitable wearable accessory craft is taught in U.S. patent application Ser. No. 16/276,736, incorporated herein by reference for all purposes. The personalized craft may include a decorative accessory craft. The decorative accessory craft may function to be displayed. The decorative craft may be displayed on a wall, ceiling, table, shelf, cabinet, window, the like, or any combination thereof. The decorative accessory craft may include a god's eye, a dream catcher, string/yarn art, the like, or any combination thereof. Non-limiting examples of decorative accessory crafts may include the Craft-tastic® Teeny Ojo de Dios Kit, the Craft-tastic® Yarn Llama Kit, the Craft-tastic® String Art Kit, or Craft-tastic® Dream Catcher Kit, commercially available from Ann Williams Group, incorporated herein by reference for all purposes. The personalized craft may include a game craft. The game craft may function to be incorporated into or used during the playing of a game. Non-limiting examples of suitable games may include a role-playing game in which the players (i.e., crafters) decorate costumes to be used during gameplay or a board game whereby the game pieces (i.e., the pieces used by each player to advance across the board) may be decorated by the respective players. Non-limiting examples of game crafts may include the Ann Williams™ Magical Wizard Adventure and the Ann William™ Magical Fairy Adventure, commercially available from Ann Williams Group; and those taught in U.S. patent application Ser. No. 16/262,198; incorporated herein by reference for all purposes.

The personalized craft may include one or more assembly apparatuses. The assembly apparatus may function to assist participants in assembling the personalized craft. The assembly apparatus may assist participants in assembling an entire craft or at least a portion thereof. The assembly apparatus may perform assembly steps that would otherwise be difficult, if not impossible, for a participant to perform. The assembly apparatus may assist a single participant in performing assembly steps that would otherwise involve more than one participant. The assembly apparatus may arrange, move, manipulate, or hold the components or any combination thereof. The assembly apparatus may perform one or more assembly steps. The assembly apparatus may be configured to be used for specific crafts. For example, a bracelet making apparatus may be configured to fabricate bracelets but may not be suitable for fabricating a scarf. The assembly apparatus may be configured to arrange, move, manipulate, or hold particular components, or any combination thereof. For example, knitting needles may be configured to arrange, move, manipulate, or hold yarn, or any combination thereof. As another example, a loom may be configured to arrange, move, manipulate, or hold string, or any combination thereof. Non-limiting examples of the assembly apparatus may include a loom, bracelet making apparatus, knitting needle, crochet hook, vice, the like, or any combination thereof. Non-limiting examples of assembly apparatuses may include the Loopdeloom™ Weaving Loom Kit or the Loopdedoo™ Spinning Loom, commercially available from Ann Williams Group; and those taught in U.S. patent application Ser. Nos. 13/357,053, 13/491,119, and 14/341,187; incorporated herein by reference for all purposes.

The personalized craft may include one or more components. The components may function to assemble to fabricate a personalized craft. The components may be arranged by one or more participants, assembly apparatuses, or both. The components may be used for specific crafts. For example, string may be suitable for making a bracelet. As another example, yarn may be suitable for making a scarf. The components may be arranged, moved, manipulated, or held by an assembly apparatus, or any combination thereof. The components may be used to fabricate one or more types of crafts. For example, string may be suitable for making a bracelet and a god's eye. The components may be used to fabricate a wearable accessory craft, decorative accessory craft, game craft, or any combination thereof. The components may include one or more media, substrates, or both.

The components may include one or more media. The media may function to fabricate and/or decorate a personalized craft. The media may include any material used for arts and crafts. The media may include, but is not limited to, one or more of ink, paint, crayon, pencil, glue, glitter, string, yarn, wire, a sticker, a jewel, a charm, a bead, a pom, paper, foam, clay, paper mâché, the like, or any combination thereof. The media may comprise physical characteristics. The physical characteristics may include color, texture, shape, size, the like, or any combination thereof. For example, a dream catcher may be fabricated from a media of string wrapped around a frame in the form of a ring. The media may be suitable for use with one type of craft or different types of crafts. For example, yarn may be suitable for any number of crafts involving weaving. The media may be chosen by a participant, designated by a questionnaire, or both. More than one media may be used to fabricate a personalized craft. For example, a dream catcher ring may be wrapped with one length of a blue string and a second length of a red string. The media may be arranged, moved, manipulated, or held by an assembly apparatus, or any combination thereof. The media may be arranged, moved, manipulated, or held by one or more participants, or any combination thereof. The media may or may not be reusable. For example, string of a dream catcher may be held in place by knots, which may be undone, and the string recovered from the dream catcher for other personalized crafts. One type of media may modify another type of media. For example, beads may be added to string. A personalized craft may be fabricated from media, substrates, or both. For example, a dream catcher comprises both media and a substrate. As another example, a bracelet may comprise only media. The media may form one or more layers. The layers may differ from each other by physical characteristics of media, separation between discrete media, manner of applying media to other media and/or a substrate, the like, or any combination thereof.

The components may include one or more substrates. The substrate may function to accept media, provide a canvas for media, provide structure for media, provide a guide for participants to arrange media thereon, or any combination thereof. The substrate may include any material and/or form suitable to accept media. The substrate may be fabricated from metal, wood, polymer, or any combination thereof. The substrate may include, but is not limited to, one or more of a canvas, piece of paper, piece of construction paper, piece of cardboard, piece of wood, frame, peg, wire, filament, chain, the like, or any combination thereof. The frame may include a ring, a wire-frame form, a cross, the like, or any combination thereof. For example, a dream catcher may include a substrate in the form of a ring that accepts a media of string wrapped circumferentially around the ring. The ring may be provided in a variety of diameters. The diameter may be about 5 cm or more, 10 cm or more, 15 cm or more, 20 cm or more, or even 25 cm or more. The diameter may be about 50 cm or less, 45 cm or less, 40 cm or less, 35 cm or less, or even 30 cm or less. The wire-frame form may comprise one or more wires bent into a two-dimensional form, a three-dimensional form, or both. The wire-frame form may stand upright on a surface. The wire-frame form may resemble an object, person, animal, the like, or any combination thereof. The cross may comprise two or more intersecting arms. The arms may extend to a uniform radial length, different radial lengths, or both. The radial length may be about 5 cm or more, 10 cm or more, 15 cm or more, 20 cm or more, or even 25 cm or more. The radial length may be about 50 cm or less, 45 cm or less, 40 cm or less, 35 cm or less, or even 30 cm or less. The arms may be arranged at any angle from each other. The angle may be about 10° or more, 20° or more, 30° or more, or even 40° or more. The angle may be about 90° or less, 80° or less, 70° or less, 60° or less, or even 50° or less. The substrate may comprise physical characteristics. The physical characteristics may include color, texture, shape, size, the like, or any combination thereof. The substrate may be chosen by a participant, designated by a questionnaire, or both. More than one substrate may be used to fabricate a personalized craft. For example, a dream catcher may include a small diameter ring that hangs concentrically within a large diameter ring. The substrate may be arranged, moved, manipulated, or held by an assembly apparatus, or any combination thereof. The substrate may be arranged, moved, manipulated, or held by one or more participants, or any combination thereof. The substrate may or may not be reusable. One type of substrate may modify another type of substrate.

The components may include one or more questionnaires. The questionnaire may function to elicit answers from participants, direct the assembly of a personalized craft, prompt conversation between participants, or any combination thereof. The questionnaire may assist in the translation of participants' personality traits, preferences, moods, emotions, or any combination thereof, into physical characteristics and/or configurations of the personalized craft. One or more questionnaires may be used in conjunction with one or more different types of crafts. For example, a questionnaire may include assembly steps that are only compatible with fabricating bracelets. The questionnaire may comprise one or more cards, manuals, booklets, cootie catchers, the like, or any combination thereof. The cootie catcher may be fabricated by folding a piece of paper. The cootie catcher may comprise four outer panels, eight inner panels, and eight fold-open panels. Participants may choose from one of the four outer panels, which limits the availability of the eight inner panels to four. Then participants choose from the four inner panels and the associated fold-open panel is un-folded to reveal what is underneath. The four outer panels, eight inner panels, or both may include one or more inquiries, answers, or both. The eight fold-up panels may include one or more answers, assembly instructions, or both. The questionnaire may be in a paper format, digital visual format, digital audio format, or any combination thereof. A digital visual format questionnaire may be accessed on a computer. A digital visual format questionnaire may be accessed via the internet, disk drive, universal serial bus (USB) drive, the like, or any combination thereof. A digital visual format questionnaire may be accessed via a code that may be sold with a personalized craft or may be purchased separate from a personalized craft. A digital audio format questionnaire may be projected by an electronic device. Non-limiting examples of suitable electronic devices may include an iPhone, commercially available from Apple Inc., and an Echo Dot, commercially available from Amazon.com, Inc. The electronic device may include artificial intelligence technology that may receive audio inputs from users and project audio outputs to users. Non-limiting examples of suitable artificial intelligence technology may include Siri, commercially available from Apple Inc., and Alexa, commercially available from Amazon.com, Inc. Questionnaires may be chosen at random, sequentially, or both, by a participant. For example, questionnaires may be printed upon one side of flashcards that can be shuffled and stacked, face-down, and chosen at random by a participant. The questionnaire may include one or more inquiries, answers to each of the inquiries, assembly instructions corresponding to each of the answers, or any combination thereof.

The questionnaires may include one or more inquiries. The inquiries may function to elicit responses, from participants, that are used to direct and/or guide the fabrication of a personalized craft. The inquiries may ask participants questions. The inquiries may ask questions about participants' personality traits, preferences, moods, emotions, or any combination thereof. The inquiries may be verbal, symbolic, or both. Symbolic inquiries may include one or more illustrations. Examples of suitable verbal inquiries may include but are not limited to “what is your favorite color?”, “what is your favorite subject in school?”, “what was your first pet?”, “where is your favorite place to vacation?”, “how do you describe yourself?”, “who do you most admire?”, “what is your favorite flower?”, and “what superpower would you pick?”. The inquiries may be chosen at random, sequentially, or both, by one or more participants. For example, crafts that involve repetitive motions during assembly (e.g., braiding a bracelet) need not have every inquiry read in a sequence because the assembly instructions are repetitive. The inquiries may be directed to a particular stage of personalized craft assembly. For example, a first stage of assembling a dream catcher may include wrapping string circumferentially around a ring and a second stage may include crossing the string along a diameter and/or chord of the ring. Each stage of assembly may be associated with the same or substantially the same assembly steps. Each stage of assembly may be associated with a particular portion of a substrate. Each stage of assembly may be associated with a discrete media. Each stage of assembly may be associated with a particular layer. The inquiries may be pre-imprinted on a questionnaire, provided by participants, or both. For example, the personalized craft may include questionnaires with blank spaces thereon where participants may author their own inquiries. As referred to herein, “pre-imprinted” may mean provided by the manufacturer. The questionnaire may include one or more answers responsive to each inquiry, assembly instructions corresponding to each of the answers, or both.

The questionnaires may include one or more answers. The answers may function to link a participant's personality traits, preferences, mood, emotions, or any combination thereof, to physical characteristics and/or configurations of a personalized craft. The answers may reveal participants' personality traits, preferences, moods, emotions, or any combination thereof. The answers may be verbal, symbolic, or both. Symbolic answers may include one or more illustrations. The answers may be responsive to inquiries. For example, verbal answers to the inquiry, “what superpower would you pick”, may include flight, invisibility, shape shifting, mind reading, talking to animals, or time travel. As another example, symbolic answers to the inquiry, “what is your favorite animal?”, may include pictures of a cat, dog, bird, rabbit, or any combination thereof. The answers may be pre-imprinted on a questionnaire, provided by participants, or both. For example, the personalized craft may include questionnaires with blank spaces thereon where participants may author their own answers. Each answer may be associated with one or more assembly instructions. The questionnaire may include answers without inquiries. Participants being presented with a plurality of answers may lead the participants to intuitively understand that they are to choose one of the plurality of answers. Content of answers may lead participants to intuitively understand the substance of the unasked/absent inquiry. For example, the questionnaire may include illustrations of different animals and participants intuitively understand that they should choose their favorite animal. Assembly instructions may be associated to answers by being written next to the answer, linked to an answer via a numerical and/or alphabetical code and corresponding look-up table, color-coding, the like, or any combination thereof. The look-up table may include assembly instructions hidden underneath scratch-off material.

The questionnaires may include one or more assembly instructions. The assembly instructions may function to direct and/or guide a participant in the fabrication of a personalized craft. The assembly instructions may direct and/or guide the assembly of one or more media onto a substrate. The assembly instructions may be verbal, symbolic, or both. Verbal assembly instructions may verbally instruct how media, substrate, or both are arranged. Symbolic assembly instructions may illustrate how media, substrate, or both are arranged. The assembly instructions may direct and/or guide the assembly of one or more media with one or more other media. The assembly instructions may direct participants to wrap, weave, twist, tie, fold, glue, tear, cut, color, paint, dye, the like, or any combination thereof. The assembly instructions may be used for one type of craft or more than one type of craft. Each assembly instruction may be associated with an answer. For example, in response to an inquiry, a participant may provide an answer and an assembly instruction associated with the answer may direct and/or guide the assembly of a component onto a substrate. The assembly instructions may include one or more media instructions, substrate instructions, arrangement instructions, participant instructions, or any combination thereof. The media instructions may designate the identity of media (e.g., string, marker), physical characteristics of media, or both. For example, the media instructions may direct the crafter to wrap a substrate with a blue string. As another example, the media instructions may direct the crafter to color a paint-by-numbers canvas with a yellow marker. The substrate instructions may designate the identity of the substrate (e.g., god's eye frame, bracelet chain, dream catcher frame), physical characteristics of the substrate, or both. For example, in the preparation of a craft the substrate instructions may direct the crafter to use a canvas having a template of a bird. As another example, the substrate instructions may direct the crafter to use a small diameter frame/ring, in the preparation of a dream catcher, chosen from a selection of various rings of different diameters. As yet another example, the media instructions may direct the crafter to fold a piece of construction paper in half. The arrangement instructions may designate a physical arrangement of the one or more media with respect to the one or more substrates. The arrangement instructions may include, but are not limited to, actions involving wrapping, weaving, tying, decorating, coloring, cutting, pasting, clipping, inserting, forming, the like, or any combination thereof. The participant instructions may designate which participant performs the media instructions, substrate instructions, arrangement instructions, or any combination thereof.

The personalized craft may be provided as a kit. The kit may include one or more personalized crafts. The kit may include the same type of craft or different types of crafts. The kit may include one or more assembly apparatuses, wearable accessory crafts, decorative accessory crafts, game crafts, components, media, substrates, questionnaires, inquiries, answers, assembly instructions, or any combination thereof. The kit may include media replacement parts including but not limited to ink, paint, crayon, pencil, glue, glitter, string, yarn, wire, stickers, jewels, charms, beads, poms, paper, foam, clay, paper mâché, the like, or any combination thereof. The kit may include substrate replacement parts including but not limited to a canvas, piece of paper, piece of construction paper, piece of cardboard, piece of wood, frame, peg, wire, filament, chain, the like, or any combination thereof. The kit may include replacement questionnaires. The replacement questionnaires may include inquiries, answers, assembly instructions, or any combination thereof. The kit may be commercially provided as a package, whereby the package includes one or more components, media, substrates, questionnaires, inquiries, answers, assembly instructions, assembly apparatuses, or any combination thereof. The kit may be commercially provided as a replacement package. The replacement package may comprise one or more of: media, substrates, questionnaires, inquiries, answers, assembly instructions, and assembly apparatuses.

The present disclosure provides for a method for making a personalized craft. The method may comprise one or more of the following steps. Some of the steps may be duplicated, removed, rearranged relative to other steps, combined into one or more steps, separated into two or more steps, or any combination thereof. The method may be performed by one or more participants. More than one participant may take turns performing the method. The method may comprise providing one or more questionnaires; directing one or more participants, for each of the one or more inquiries, to select one of the plurality of answers; and directing the one or more participants to manipulate one or more components in accordance with the one or more assembly instructions corresponding to the one of the plurality of answers. These steps may be repeated until the personalized craft is complete. The crafter may repeat the following steps until the personalized craft is complete: receive an inquiry, provide an answer, receive assembly instructions, and carry out assembly instructions. The crafter may repeat the following steps until the personalized craft is complete: communicate an inquiry to another crafter, receive an answer from the other crafter, and communicate assembly instructions to the other crafter. As referred to herein, “complete” or “completed”, in relation to the extent of assembly of the personalized craft, may include when a pre-determined aesthetic is achieved (e.g., a dream-catcher pre-determined to comprise a ring fully wrapped in string and also having a string spanning the center of the ring in the shape of a 5-point star), one or more of the media is exhausted, a substrate runs out of space to receive media, the crafter reads through all inquiries included in a questionnaire, the crafter subjectively decides to cease assembly, or any combination thereof. The questionnaires, inquiries, or both may be chosen at random or sequentially by a participant. The method may include disassembling a personalized craft.

In some configurations, the personalized craft may include a god's eye (i.e., a decorative accessory craft). A kit comprising the personalized craft may include string and a cross fabricated from popsicle sticks. The string may include one or more lengths of strings. The one or more strings may have the same or different physical characteristics. In one aspect, a participant may read inquiries from a questionnaire, choose an answer from a plurality of answers, and perform assembly instructions associated with the chosen answer. In another aspect, two or more participants may take turns reading inquiries to the other participant, the other participant may choose an answer from a plurality of answers and perform assembly instructions associated with the chosen answer. The assembly instructions may direct participants to wrap strings around arms of the cross, starting from the center, and working radially outward. The string may form discrete layers, differing from other layers by physical characteristics of the string. With respect to a god's eye, the assembly instructions may include color of string, width of a layer, arms of the cross to tie the string to, number of wrappings, stringing beads through string, providing a gap between layers, or any combination thereof.

In some configurations, the personalized craft may include a necklace (i.e., a wearable accessory craft). A kit comprising the personalized craft may include a chain, charms, beads, or any combination thereof. In one aspect, a participant may read inquiries from a questionnaire, choose an answer from a plurality of answers, and perform assembly instructions associated with the chosen answer. In another aspect, two or more participants may take turns reading inquiries to the other participant, the other participant may choose an answer from a plurality of answers and perform assembly instructions associated with the chosen answer. The assembly instructions may direct participants to add charms, beads, or both to a chain. With respect to a necklace, the assembly instructions may include color of charms/beads, shape of charms/beads, order of applying charms/beads to the chain, or any combination thereof.

In some configurations, the personalized craft may include a bracelet (i.e., wearable accessory craft). A kit comprising the personalized craft may include one or more lengths of string. In one aspect, a participant may read inquiries from a questionnaire, choose an answer from a plurality of answers, and perform assembly instructions associated with the chosen answer. In another aspect, two or more participants may take turns reading inquiries to the other participant, the other participant may choose an answer from a plurality of answers and perform assembly instructions associated with the chosen answer. The assembly instructions may direct participants to weave and/or tie the string in particular configurations to form a bracelet. With respect to bracelets, the assembly instructions may include physical characteristics of string, lengths of strings, types of weaves, types of knots, or any combination thereof.

In some configurations, the personalized craft may include coloring a templated depiction (e.g., color-by-numbers) on paper (i.e., decorative accessory craft). The templated depiction may be populated by color. A kit comprising the personalized craft may include markers, construction paper, a templated depiction on the construction paper, or any combination thereof. In one aspect, a participant may read inquiries from a questionnaire, choose an answer from a plurality of answers, and perform assembly instructions associated with the chosen answer. In another aspect, two or more participants may take turns reading inquiries to the other participant, the other participant may choose an answer from a plurality of answers and perform assembly instructions associated with the chosen answer. With respect to coloring construction paper, the assembly instructions may include but are not limited to what features and/or portions of the templated depiction a participant is to color, marker color, or both.

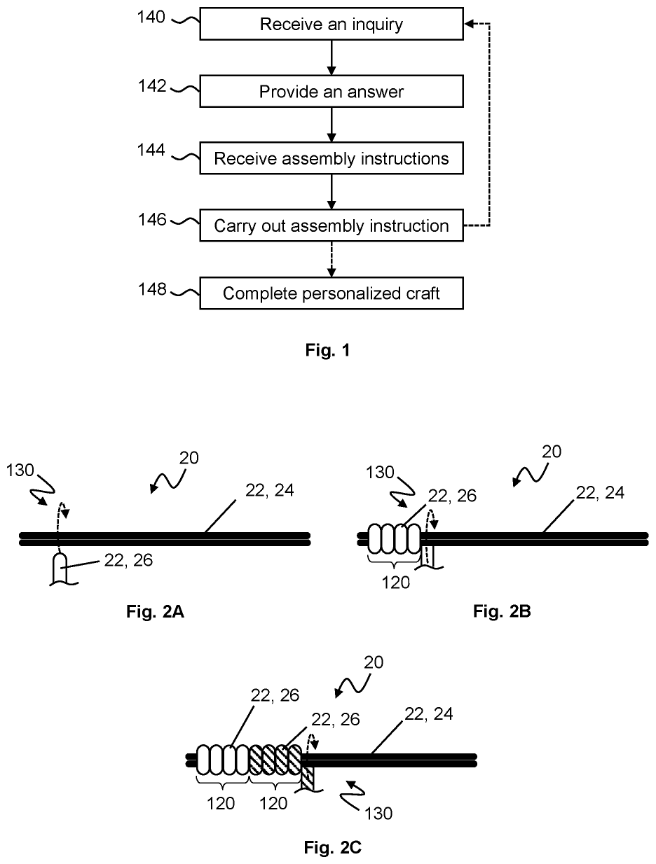

FIG. 1 illustrates a flowchart of a method according to the present disclosure. A participant receives an inquiry 140 from a questionnaire, provides an answer 142 to the inquiry, and receives assembly instructions 144 corresponding to the answer provided. The participant then carries out the assembly instructions 146 with media 24 and/or substrates 26, such as that illustrated in FIGS. 2A-2C. These steps are repeated until the personalized craft is completed 148.

FIGS. 2A-2C illustrate assembly steps 130 for a personalized craft 20. The personalized craft 20 is a bracelet. The personalized craft 20 comprises three components 22 including a substrate 24 and two media 26. The two media 26 comprise different physical characteristics. The substrate 24 is a bundle of strings and the media 26 are single strings. As shown in FIGS. 2A and 2B, a first media 26 is wrapped around the substrate 24 four times, by the crafter, forming a first layer 120. As shown in FIG. 2C, a second media 26 is wrapped around the substrate 24 four times, by the crafter, forming a second layer 120.

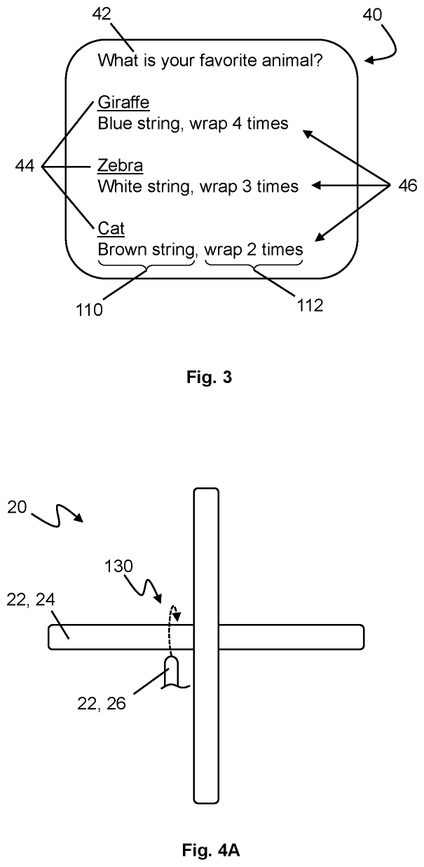

FIG. 3 illustrates a questionnaire 40. The questionnaire 40 is configured for use with the personalized craft 20 illustrated in FIGS. 2A-2C. The questionnaire 40 includes an inquiry 42, three answers 44, and three sets of two assembly instructions 46. Each set of assembly instructions 46, located directly below each of the three answers 44, correspond to an answer 44. Each set of assembly instructions 46 includes a media instruction 110 and an arrangement instruction 112.

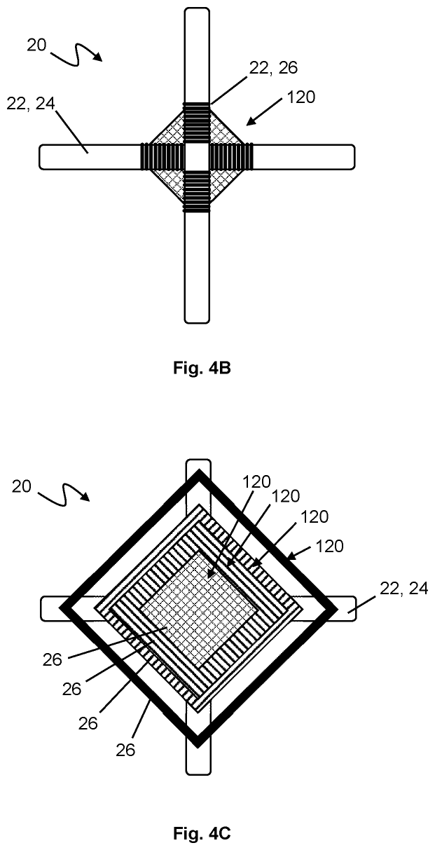

FIGS. 4A-4C illustrate a personalized craft 20. The personalized craft 20 is a god's eye. The personalized craft 20 comprises five components 22 including a substrate 24 and four media 26. The substrate 24 is a cross having four arms oriented at 90° with respect to each other. The media 26 is string. FIG. 4A illustrates an assembly step 130 for a personalized craft 20. The assembly step 130 involves wrapping a media 26 around an arm of the substrate 24. The assembly step 130 is repeated on adjacent arms, working circumferentially around the substrate 24 with the media 26 extending between adjacent arms, until a layer 120 is formed, as shown in FIG. 4B. FIG. 4B illustrates the personalized craft 20 after the assembly steps 130 illustrated in FIG. 4A is complete. The media 26 is wrapped around the substrate 24 repeatedly, in a manner conventionally utilized for a god's eye, to form a layer 120. FIG. 4C illustrates the personalized craft 20 illustrated in FIGS. 4A-4B after completion. Three more media 26 have been introduced and wrapped around the substrate 24, according to the assembly step 130 shown in FIG. 4A, forming three more respective layers 120. A gap is located between the outermost layer 120 and the next layer 120.

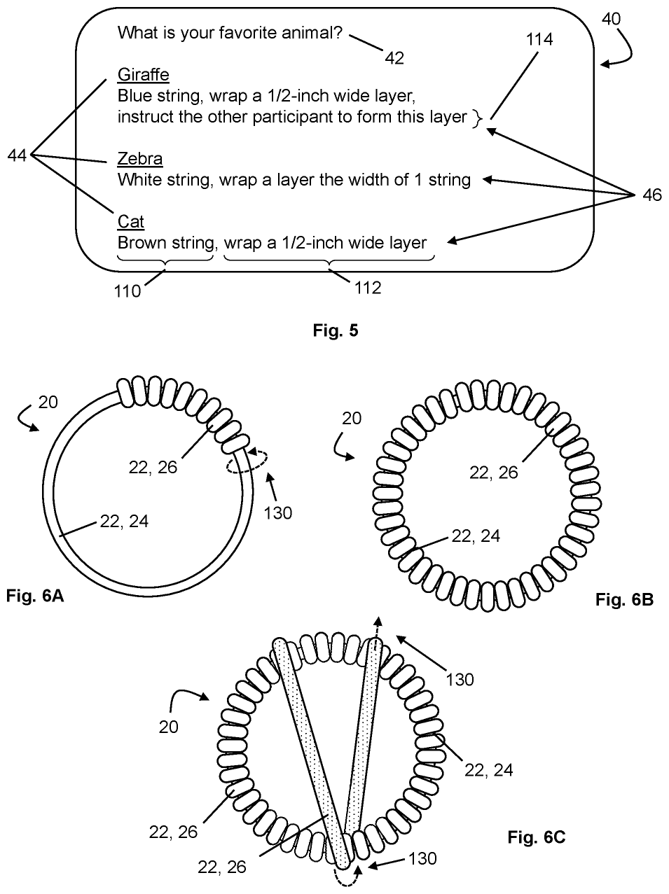

FIG. 5 illustrates a questionnaire 40. The questionnaire 40 is configured for use with the personalized craft 20 illustrated in FIGS. 4A-4C. The questionnaire 40 includes an inquiry 42, three answers 44, and three sets of assembly instructions 46. Each set of assembly instructions 46, located directly below each of the three answers 44, correspond to an answer 44. Each set of assembly instructions 46 includes a media instruction 110 and an arrangement instruction 112. The first assembly instruction 46 also includes a participant instruction 114.

FIGS. 6A-6C illustrate assembly steps 130 for a personalized craft 20. The personalized craft 20 is a dream catcher. The personalized craft 20 includes three components 22 including a substrate 24 and two media 26. The substrate 24 is a ring. A first assembly step 130 involves repeatedly wrapping a first media 26 around the substrate 24 circumferentially, as shown in FIG. 6A. FIG. 6B illustrates the personalized craft 20 after the first assembly step 130 shown in FIG. 6A. The first media 26 is repeatedly wrapped around the substrate 24 to completely cover the substrate 24. FIG. 6C illustrates a second assembly step 130 for the personalized craft 20. The second assembly step 130 involves wrapping the second media 26 over the first media 26, spanning a void in the center of the substrate 24, in a manner conventionally utilized for dream catchers.

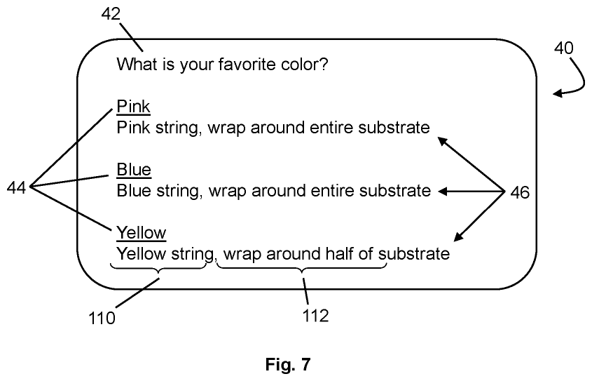

FIG. 7 illustrates a questionnaire 40. The questionnaire 40 is configured for use with the personalized craft 20 illustrated in FIGS. 6A-6C. The questionnaire 40 includes an inquiry 42, three answers 44, and three sets of assembly instructions 46. Each assembly instruction 46, located directly below each of the three answers 44, correspond to an answer 44. Each set of assembly instructions 46 includes a media instruction 110 and an arrangement instruction 112.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

### REFERENCE NUMERALS

20 Personalized craft

22 Component

24 Substrate

26 Media

40 Questionnaire

42 Inquiries

44 Answer

46 Assembly instructions

100 Wearable accessory craft

102 Decorative accessory craft

104 Game craft

110 Media instruction

112 Arrangement instruction

114 Participant instruction

120 Layer

130 Assembly step

140 Receive an inquiry

142 Provide an answer

144 Receive assembly instruction

146 Carry out assembly instruction

148 Complete personalized craft

What is claimed is:

1. A personalized craft comprising:
one or more components;
one or more questionnaires, including:
one or more inquiries and
a plurality of answers to each of the one or more inquiries; and
one or more assembly instructions, corresponding to each of the plurality of answers;
wherein each of the one or more assembly instructions are a step of assembly of the one or more components to fabricate the personalized craft.

2. The personalized craft according to claim 1, wherein the one or more components include one or more media, substrates, or both;
wherein the one or more media includes one or more of ink, paint, crayon, pencil, glue, glitter, string, yarn, wire, a sticker, a jewel, a charm, a bead, a pom, paper, foam, clay, paper mâché, or any combination thereof; and
wherein the one or more substrates include one or more of a canvas, piece of paper, piece of construction paper, piece of cardboard, piece of wood, frame, peg, wire, filament, chain, or any combination thereof.

3. The personalized craft according to claim 1, wherein the personalized craft includes a wearable accessory craft, decorative accessory craft, game craft, or any combination thereof;
wherein the wearable accessory craft is worn on a body, article of clothing, bag, purse, backpack, or any combination thereof;
wherein the decorative accessory craft is displayed on a wall, ceiling, table, shelf, cabinet, window, or any combination thereof; and
wherein the decorative accessory craft is incorporated into or used during the playing of a game.

4. The personalized craft according to claim 2, wherein the one or more assembly instructions include one or a combination of the following:
one or more media instructions, which designates a physical characteristic of the one or more media;
one or more substrate instructions, which designates a physical characteristic of the one or more substrates;
one or more arrangement instructions, which designates a physical arrangement of the one or more media with onto the one or more substrates; and
one or more participant instructions, which designates one or more participants to perform the one or more media instructions, substrate instructions, arrangement instructions, or any combination thereof.

5. The personalized craft according to claim 1, wherein the one or more inquiries, the plurality of answers, or both are pre-determined, custom-authored by one or more participants, or both.

6. The personalized craft according to claim 1, wherein the one or more questionnaires direct one or more participants in the fabrication of the personalized craft.

7. The personalized craft according to claim 6, wherein the one or more questionnaires direct fabrication of the personalized craft with unique physical characteristics reflecting one or more personality traits, preferences, moods, or emotions of the one or more participants, or any combination thereof.

8. A kit for a personalized craft comprising:
one or more components;
one or more questionnaires, including:
one or more inquiries and
a plurality of answers to each of the one or more inquiries; and
one or more assembly instructions, corresponding to each of the plurality of answers;
wherein each of the one or more assembly instructions are a step of assembly of the one or more components to fabricate the personalized craft.

9. The kit according to claim 8, wherein the one or more components include one or more media, substrates, or both;
wherein the one or more media includes one or more of ink, paint, crayon, pencil, glue, glitter, string, yarn, wire, a sticker, a jewel, a charm, a bead, a pom, paper, foam, clay, paper mâché, or any combination thereof; and
wherein the one or more substrates include one or more of a canvas, piece of paper, piece of construction paper, piece of cardboard, piece of wood, frame, peg, wire, filament, chain, or any combination thereof.

10. The kit according to claim 8, wherein the personalized craft includes a wearable accessory craft, decorative accessory craft, game craft, or any combination thereof;
wherein the wearable accessory craft is worn on a body, article of clothing, bag, purse, backpack, or any combination thereof;
wherein the decorative accessory craft is displayed on a wall, ceiling, table, shelf, cabinet, window, or any combination thereof; and
wherein the decorative accessory craft is incorporated into or used during the playing of a game.

11. The kit according to claim 9, wherein the one or more assembly instructions include one a combination of the following:
one or more media instructions, which designates a physical characteristic of the one or more media;
one or more substrate instructions, which designates a physical characteristic of the one or more substrates;
one or more arrangement instructions, which designates a physical arrangement of the one or more media onto the one or more substrates; and
one or more participant instructions, which designates one or more participants to perform the one or more media instructions, substrate instructions, arrangement instructions, or any combination thereof.

12. The kit according to claim 8, wherein the one or more questionnaires direct one or more participants in the fabrication of the personalized craft.

13. The kit according to claim 12, wherein the one or more questionnaires direct fabrication of the personalized craft with unique physical characteristics reflecting one or more personality traits, preferences, moods, or emotions of the one or more participants, or any combination thereof.

14. A method for making a personalized craft comprising:
(a) providing one or more questionnaires, the one or more questionnaires including one or more inquiries and a plurality of answers to each of the one or more inquiries;
(b) directing one or more participants to select one of the plurality of answers; and
(c) directing the one or more participants to physically arrange one or more media onto one or more substrates in accordance with one or more assembly instructions associated with the one of the plurality of answers.

15. The method according to claim 14, wherein steps (a) through (c) are repeated until the personalized craft is complete.

16. The method according to claim 14, wherein the method is performed by two or more participants.

17. The method according to claim 16, wherein the two or more participants take turns performing a single iteration of steps (a) through (c).

18. The method according to claim 14, wherein the one or more assembly instructions include one or a combination of the following:
one or more media instructions, which designates a physical characteristic of the one or more media;
one or more substrate instructions, which designates a physical characteristic of the one or more substrates;
one or more arrangement instructions, which designates a physical arrangement of the one or more media onto the one or more substrates; and
one or more participant instructions, which designates the one or more participants to perform the one or more media instructions, substrate instructions, arrangement instructions, or any combination thereof.

19. The method according to claim 14, wherein the one or more questionnaires direct the one or more participants in the fabrication of the personalized craft.

20. The method according to claim 19, wherein the one or more questionnaires direct fabrication of the personalized craft with unique physical characteristics reflecting one or more personality traits, preferences, moods, or emotions of the one or more participants, or any combination thereof.
